(19) United States
(12) Patent Application Publication
(10) Pub. No.: US 2020/0320162 A1
(43) Pub. Date: Oct. 8, 2020

(54) MANAGEMENT OF CONTENT OBJECTS FOR INGESTION BY MULTIPLE ENTITIES

(71) Applicant: Primer Technologies, Inc., San Francisco, CA (US)

(72) Inventor: John Neil Bohannon, San Francisco, CA (US)

(21) Appl. No.: 16/374,130

(22) Filed: Apr. 3, 2019

(51) Int. Cl. G06F 17/22; G06F 8/51

(52) U.S. Cl. CPC G06F 17/2217; G06F 8/51; G06F 17/2264; G06F 17/2247

(57) ABSTRACT

Systems, methods, and software described herein generate synonymous mutations of content objects. In at least one example, a method includes identifying a content object from a content source and identifying language elements in the content object. The method further translates the language elements from a first structure to a second structure, wherein the second structure provides one or more synonymous mutations of the first structure. The method also generates a second content object from the content object by replacing the one or more language elements in the first structure with the one or more language elements in the second structure and provides that second content object for display to one or more users.

### BACKGROUND

Content objects, such as documents, emails, articles, program code, and other similar content items, often include sensitive information that can be harmful if disseminated to one or more persons or services. This information may include trade secrets, security information, passwords, project plans, or other similar information that is sensitive to an organization. In many implementations, organizations may attempt to limit accessibility to sensitive content objects by requiring credentials, such as usernames, passwords, tokens, and the like. However, the management of the security permissions for each individual content item can be difficult and cumbersome, especially as the size of a database that stores the content items is increased. Moreover, while security may be increased by limiting the individuals and groups with access to the content objects, difficulties can also arise in identifying a specific source when information is leaked from one of the content items.

### Overview

Provided herein are enhancements for managing content items for multiple users. In one implementation, a method of operating an object management system includes identifying a content object and identifying one or more language elements in a first structure from the content object. The method further includes translating the one or more language elements from the first structure to a second structure and generating a second content object from the content object using the translation. Once translated, the method further provides, for display, the second content object.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment to manage the structure of content items according to an implementation.

FIG. 2 illustrates an operational scenario of modifying a structure of a content object according to an implementation.

FIG. 3 illustrates an operation of operating an object management system to modify a structure of a content object according to an implementation.

FIG. 4 illustrates an operational scenario of identifying a content source according to an implementation.

FIG. 5 illustrates an operation of an object management system to identify a content source according to an implementation.

FIG. 6A-6B illustrate an operational scenario of distributing synonymous mutations of a content object and monitoring usage of the synonymous mutations according to an implementation.

FIG. 7 illustrates an object management computing system according to an implementation.

### DETAILED DESCRIPTION

Object management systems may be used to maintain and provide content objects to users, organizations, or other entities with credentials to access the content objects. The content objects may comprise documents, program code files, web pages, emails, or some other type of content object. To monitor the different entities that are accessing the content objects, an object management system may provide synonymous mutations on the content objects prior to providing the content objects to requesting entities. For example, a document may be stored by the content object that is accessible to a plurality of users. Rather than providing the original document to the requesting users and other entities, the object management system may translate the original document version into a subsequent document version using synonymous mutations, such that the same information, such as facts, opinions, and other data points are functionally equivalent, but provided in a different structure from the original document. This permits the object management system to generate uniquely distinct but functionally equivalent versions of a content object for various entities capable of accessing the content object. Thus, while a first entity may be provided with a first set of synonymous mutations of a content object, a second entity may be provided with a second set of synonymous mutations that represent a distinct version of the same content object.

In generating synonymous mutations for a content object, the object management system may identify one or more language elements within the original content object that can be modified to generate the synonymous mutations. These language elements may comprise a sequence of characters, symbols, words, spaces, punctuation, carriage returns, or some other language items. The language elements may be selected at random, may be selected based on the sequence or format of the language element, may be selected based on the location within the content object, or may be selected in any other similar manner. For example, the object management system may identify one or more sentences within a content object to be translated into an alternative format. In translating the one or more sentences, the object management system may perform natural language translation using information stored in one or more data structures, may manipulate the distribution of stylistic features such as spaces, dashes, bullet points, punctuation, or other portions of the text, may change words or phrases to synonymous versions, or may perform other translation mechanisms.

Once the synonymously mutated content objects are generated and provided for display to one or more entities, the object management system may further monitor one or more services to determine when information is shared from the synonymous mutations. The services may comprise social media services, news services, or some other service. In identifying posts related to the synonymous mutations, the object management system may compare language elements of the post to the content objects that were provided to the various entities. Because the entities may be provided with different translations of the original content object, the language elements used in the post may correspond to a particular mutation of the original content object. This may permit the object management system to provide a notification to an administrator associated with the object management system, wherein the notification may identify the entity associated with distributing information from the content object, the information that was shared, the original content object, or some other information. In some implementations, in addition to or in place of generating notifications when posts are identified, the object management system may further monitor how information from a synonymously mutated content object is distributed. This may include generating a timeline indicative of when new posts are identified, the quantity of posts generated from the particular synonymously mutated content object, a tree indicating the source of each post rooting back to the synonymously mutated content object, or some other information related to the information distribution from a synonymously mutated content object.

In some implementations, when the synonymously mutated content objects are generated from the original content object, portions of the original content object may be mutated differently for each of the mutated content objects. For example, a first paragraph in the original content object may be synonymously mutated to a second paragraph for a second content object, whereas the same first paragraph may be synonymously mutated to a third paragraph for a third content object. These different paragraphs may use different word choice, spaces, punctuation, or some other text element, but provide the same information or data points. In determining different structure for each of the synonymously mutated versions, the object management system may use natural language processing, synonym searches, spaces, or some other language translation operation. In some examples, the object management system may extract the information (statements of fact, opinions, values, or other elements) from the segment of the original content object. Once extracted, the content management system may generate natural language the provides the same information in varying different formats for each of the corresponding entities.

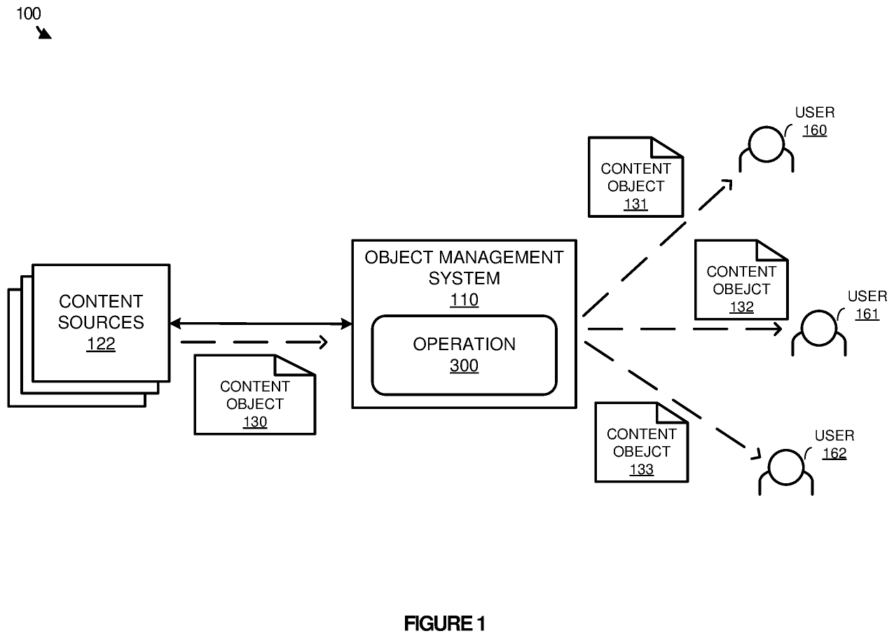

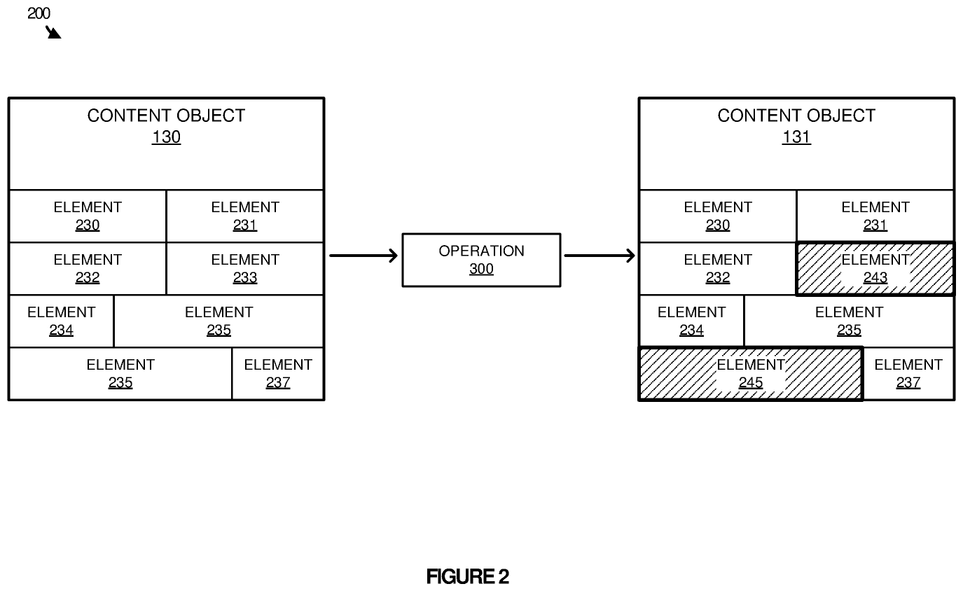

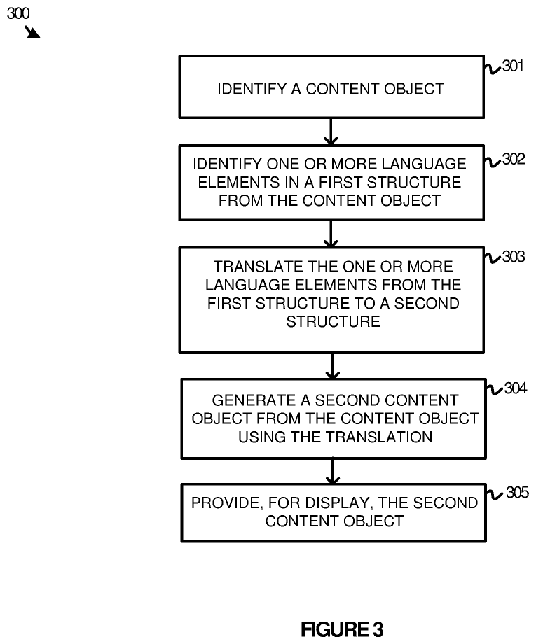

FIG. 1 illustrates a computing environment 100 to manage the structure of content items according to an implementation. Computing environment 100 includes content sources 122, object management system 110, content objects 130-133, and users 160-162. Object management system 110 is used to provide operation 300 that is further described in FIGS. 2 and 3.

In operation, content sources 122 generate content objects that are identified or obtained by object management system 110. Content sources 122 may comprise one or more users, organizations, or some other similar content source cable of generating content objects, wherein the content objects may comprise news stories, emails, program code, press releases, documents or any other text related content. When a content item 130 is identified by object management system 110, object management system 110 may modify the structure of the content object to provide the object to one or more users or other entities associated with object management system 110. For example, a document may be submitted to a database associated with object management system 110. Rather than providing users associated with the database with the original copy of the document, object management system 110 may be used to identify language elements in the documents that correspond to a first language structure and modify the first language structure to a second language structure. The language structures may comprise combinations of symbols, characters, words, punctuation, spaces, or some other similar element. For example, a language element in the document may correspond to a first structure that comprises a first word followed by a period, a single space, and a second word. In modifying the first structure to a second structure, object management system 110 may maintain the information of the document and modify the language such that the first word is followed by a period, two spaces, and the second word. Thus, the document is changed from a first version to a second version, but the changes fail to modify the information of the document. This modification is referred to as a synonymous mutation, where the information is consistent between the versions of the content object, but the structure of the language providing the information is changed. The language structures may be modified based on natural language processing, may be based on synonyms, may be based on similar operating program code (e.g., different formats for loops), or may be modified in any other manner. In some examples, object management system 110 may identify relevant data points (statements of fact, opinions, or other information) in the content object and modify the natural language that provides that information.

Although demonstrated in the previous example as translating language elements in a document or other similar text object, it should be understood that similar operations may be employed in program code. For example, language elements, such as functions, variables, or other similar elements may be identified in the code and translated to a second version, such that the second version provides the same functionality, but uses the different language elements. Advantageously, the object management system may monitor the distribution and use of code by the different entities with access to the program code.

In some implementations, the modification information for each of users 160-162 may be maintained by object management system 110. In particular, when a new content object is generated for a user, information about the changes to the original content object may be maintained to determine whether a user of users 160-162 posts or provides any information about the incident to one or more other services. In maintaining the modification information for each of content objects 131-133, object management system 110 may store metadata capable of translating the content object 130 to the corresponding user content object, object management system 110 may store each of content objects 131-133, or object management system 110 may store any other information capable of identifying the unique content object of content objects 131-133. In some examples, each content object may be stored with information indicating the one or more users associated with the content object. Thus, object management system 110 may store each of the individual content objects provided to the various users in computing environment 100 along with any information that associates the specific content object to one or more users.

FIG. 2 illustrates an operational scenario 200 of modifying a structure of a content object according to an implementation. Operational scenario 200 includes content objects 130-131 from computing environment 100 of FIG. 1. Content object 130 includes language elements 230-237, while content object 131 includes language elements 230-232, 234-235, 237, 243, and 245. While demonstrated with two content objects in the example of FIG. 2, it should be understood that similar operations may be provided to any other content object that is provided to an end user.

As described previously, as content objects are generated from one or more content sources, an object management system may be used to modify the structure of language within the content objects. In particular, the object management system may identify portions of the content object that correspond to a first structure, wherein the structure may comprise characters, symbols, words, spaces, punctuation, or other textual elements, and translate the first structure to a second structure that can then be provided to a requesting entity associated with the content object. As an example, a user may generate a document (content object) that can be viewed by one or more other users as part of an organization. Rather than providing the original content object to the users, the object management system may be used to make modifications to the document such that unique versions of the document are provided to the end user. These unique versions may include the same information in the document, but may include modifications to the formatting of the text that are unrecognizable to the end users. Some of these changes may include an increased or decreased quantity of spaces between words, an increased or decreased quantity of spaces following a sentence, and an increased or decreased quantity of carriage returns between paragraphs, or some other similar modification that does not modify that word choice selected for the document.

In some implementations, in addition to or in place of modifying the quantity of spaces or carriage returns in the document, operation 300 may be used to modify one or more words or phrases in the document to synonyms that differentiate the new content object from the original content object. For example, a modification to a document may change the term “at least one” to “one or more,” where the modification maintains the information provided in the document, but ensures that the same information is portrayed within the document. These modifications may be referred to as synonymous mutations, wherein content object 131 comprises at least one synonymous mutation from content object 130. In some examples, each of the generated content objects may comprise different synonymous mutations of content from the original content object, wherein each content object may comprise different structures of one or more language elements that can be used to differentiate between the various content objects. For example, from an original document, each content object generated from the original document may include different synonymously mutated paragraphs. Thus, while a first document may include a first paragraph with a first text or language structure, a second document may include a second paragraph that provides the same information, but in a second text or language structure. The information may include statements of fact, opinions, or some other information or data point identified in the original content object. Further, the content objects generated from the original content object would each comprise a different structure from the original, preventing the various entities from identifying the structure of the original content object.

Here, when content object 130 is identified by operation 300, operation 300 identifies that element 233 should be translated to element 243. This modification may include changing words, spaces, carriage returns or some other similar modification to content object 130. Additionally, similar operations may be used by operation 300 to translate language element 235 to language element 245 in content object 131. In some implementations, the modifications that are made to content object 130 may be based on an algorithm, where the algorithm may select language elements for modification based on the structure of the language elements, based on the user requesting the content object, based on the ratios or a quantity of modifications to be made to the original document, or based on any other similar factor. As an example, when content object 130 is to be translated into content object 131, operation 300 may identify language elements that correspond to a first structure and select one or more of the language elements to be translated into a second structure. In selecting the one or more language elements, operation 300 may identify all of the language elements that correspond to a first structure (e.g., a sequence comprising: first word, period, space, second word). Once identified, operation 300 may select a subset of the first structure elements and translate the subset of elements to a second structure. This subset of elements may be selected such that a newly generated content object is different than the original content object and any other content objects provided to other users associated with the object management system. The subset of elements may be selected at random, may be selected based on an algorithm, or may be selected in any other similar manner. In some examples, operation 300 may identify multiple different structures of interest within a content object and translate each of the structures to a corresponding different structure. Thus, rather than selecting language elements that are associated with a single structure, operation 300 may select elements that apply to any one of a plurality of structures.

FIG. 3 illustrates an operation 300 of operating an object management system to modify a structure of a content object according to an implementation. Operation 300 is referenced parenthetically in the paragraphs that follow with reference to systems and elements of computing environment 100 of FIG. 1. Although demonstrated as generating a single second content object from an original content object, it should be understood that similar operations may be used for multiple content objects to be provided to users and other consuming entities.

As depicted, operation 300 includes identifying (301) a content object 130 from content sources 122, wherein the content object may comprise a document, a web page, a news report, a press release, program code, or some other type of content object. In response to identifying the content object, object management system 110 may identify (302) one or more language elements in a first structure from the content object. These language elements may comprise combinations of characters, symbols, words, punctuation, spaces, carriage returns, or some other structural element. As an example, a first structure may correspond to an order of text as follows: a question mark, a single space, and a word. As a result, object management system 110 may identify one or more language elements in content object 130 that correspond to the first structure. Once identified, object management system 110 and operation 300 may translate (303) the one or more language elements from the first structure to a second structure, wherein the second structure corresponds to an alternative sequence or order of characters, symbols, words, spaces, punctuation, carriage returns, or other text-based elements. Returning to the example of the first structure that corresponds to the order of a question mark, a single space, and a word, object management system 100 may translate the structure to an order of text as follows: question mark, two spaces, and a word. As a result, although the same information is conveyed, an additional space may be added to the text to distinguish the new content object from the original content object and

After translating a portion of the text of content object 130 from a first structure to a second structure, operation 300 further generates (304) a second content object from the content object using the translated one or more language elements in the second structure. In some implementations, the one or more language elements in the second structure may be used to replace the one or more language elements in the first structure to generate the second content object. Once generated, operation 300 may provide (305) the second content object to a requesting entity. Referring to an example from computing environment 100, when user 160 requests access to content object 130, object management system 110 may generate content object 131 that may include the same information, but may replace one or more language elements in a first structure with one or more elements of a second structure. In some implementations, in generating the new content object, object management system 110 may maintain the words of the content item, but may transparently replace spaces, punctuation, and other elements from the content item. These modifications may include adding or removing spaces in the content item, adding or removing carriage returns in the content item, or providing some other similar modification to the content item.

In some examples, content objects 131-133 are generated when they are requested by a corresponding user of users 160-162. In other examples, at least a portion of the objects may be generated prior to a request from users 160-162. In this configuration, when content object 130 is identified by object management system 110, object management system may generate at least a portion of new content objects 131-133, such that they are prepared prior to a request by a corresponding user.

In some implementations, object management system 110 may maintain information that stores content objects 131-133 and associates content objects 131-133 to content object 130. In some examples, in storing content objects 131-133, object management system 110 may store the entire content objects, however, object management system 110 may also store information that can be used to create the corresponding content object from content object 130. Thus, rather than storing the entirety of content object 131, object management system 110 may merely store information capable of converting content object 130 to content object 131.

Further, in addition to storing information about the content objects themselves, object management system 110 may store metadata information to associate each of the content objects with the corresponding destination entity. As a result, one or more data structures may be used to associate each content object of content objects 131-133 with a corresponding user of users 160-162. In some implementations, the association of the users with the corresponding content object may be used by object management system 110 to determine whether a specific version of the content object has been shared using one or more services. In particular, object management system 110 may monitor one or more services, such as email services, social media services, news services, or other similar services to determine when a content object is posted that is related to one of content objects 131-133. Once a content object is identified, object management system 110 may determine the source content object from content objects 131-133. For example, a news source may publish an article that includes at least a portion of content object 131. As a result, object management system 110 may monitor the news source to identify when the article is published and may compare the language in the article to that of content objects 131-133. In some examples, when the article includes a quote of at least a subset of the content from the content object, the quoted information may be compared to the unique language elements for each of the content objects. As an example, if content object 131 used a single space following a period and content object 132 used two spaces following a period, object management system 110 may be able to distinguish between quotes from content object 131 and content object 132.

Although described in a previous example as using manipulations to spaces and carriage returns to generate the unique content object versions for users 160-162, it should be understood that other manipulations may be made while maintaining the information in the original content item. These changes may include word choice changes, sentence organization modifications, or other similar modifications, wherein the information or data points remain consistent, but the text is unique to each of the requesting users. In some implementations, content objects 131-133 may comprise synonymous mutations, wherein the synonymous mutations are generated using a natural language processing, synonym replacement, synonymous function replacement, or some other similar operation. As an example, using program code, object management system 110 may identify a language element that corresponds to a first loop format. Once identified, object management system 110 may translate the first loop format to a second loop format, such that the functionality of the loop is maintained, but differs from the original content object. This loop format may be modified for all synonymously mutated versions of the program code or may be modified for a subset of the synonymously mutated versions.

In at least one implementation, in generating the synonymous mutations of the original content object, object management system 110 may identify information or data points in the original content object. The data points may comprise numerical values, names, statements of fact, opinions, or some other values within the text of the content item. Once the data points are identified, object management system 110 may generate the second content items that are provided to the end users using natural language processing or generator. In particular, the natural language processing may assemble the facts into sentences or other text that provide the same information as the original content object but are structured differently from the original content object. These different structures may include different organization of the data points, different word choice (synonyms), or some other differentiation between the texts of the various content items.

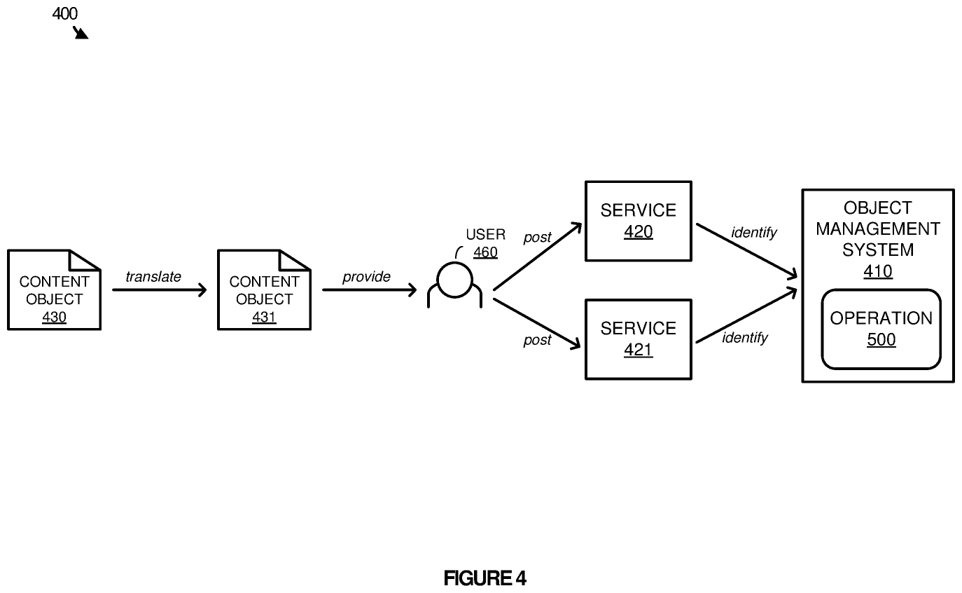

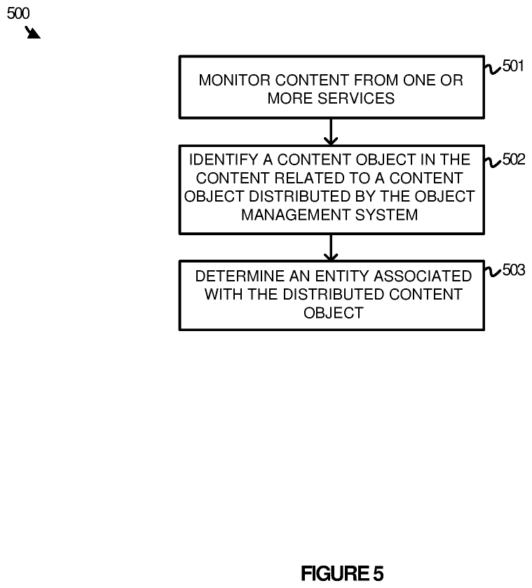

FIG. 4 illustrates an operational scenario 400 of identifying a content source according to an implementation. Operational scenario 400 includes content objects 430-431, user 460, services 420-421, and object management system 410 that performs operation 500 as further described in FIG. 5.

As described herein, when content objects are identified by an object management system 410, the object management system may perform translation operations to modify the first version of the object to a second version of the object. Here, when content object 430 is identified, the object management system may perform the required translation operations to generate content object 431. In some implementations, the translation operation may include identifying one or more language elements that correspond to one or more first structures, wherein the structures may comprise sequencing of characters, symbols, words, spaces, punctuation, carriage returns, or some other text element. As an example, a first structure may include the following sequence of: any word, any punctuation, a space, and any word. The object management system may identify one or more language elements in content object that correspond to the first structure and translate the one or more language elements to a second structure. In some implementations, the translation may include adding or removing spaces to generate the second structure, add or remove carriage returns to generate the second structure, or providing any other similar operation that may maintain the words from the original content object while modifying other elements of the text. In some implementations, all of the language elements that correspond to the first structure may be selected, however, it should be understood that the language elements may be selected at random, based on an algorithm or based on some other function.

Once the content object 431 is generated, content object 431 is provided to user 460. In some examples, content object 431 may be generated when user 460 requests access to content object 430, however, content object 431 may be generated when content object 430 is identified and provided when user 460 requests access to content object 430. After providing content object 431, user 460 may provide information from content object 431 that is used in generating posts for services 420-421. Services 420-421 may comprise web services, social media pages, news sources, or some other similar service. For example, when content object 431 is provided to user 460, the user may extract a portion of the content object 431 and provide the portion to services 420-421 for distribution.

To monitor the use and distribution of the content items that are provided to users, such as user 460, object management system 410 may monitor various services to determine if any posts associated with the services are associated with a content object that has been provided to a user. In particular, when a post is generated, object management system may compare the content within the post to the content objects that have been distributed to the various users. If a match is identified based on the content of the post meeting criteria to match another content item distributed by object management system 410, then a flag or notification may be generated that user 460 may have distributed information from the content object.

FIG. 5 illustrates an operation 500 of an object management system to identify a content source according to an implementation. The processes of operation 500 are described parenthetically in the paragraphs that follow with reference to systems and elements of operational scenario 400 of FIG. 4.

As depicted, operation 500 may monitor (501) content from one or more services, wherein the services may correspond to webs services, such as social media services, new services, blog services, or some other similar service. While monitoring the content, operation 500 may identify (502) a content object in the content related to a content object that was distributed by the object management system and may determine (503) an entity associated with the distributed content object. In some implementations, object management system 410 may when a new content object is identified from sources 420-421 compare language elements in the content object to language elements in content objects distributed by object management system 410. In some examples, rather than comparing a monitored content object to all of the objects distributed by object management system 410, object management system 410 may determine a topic associated with the identified content object and may compare language attributes of the identified content object to distributed content objects associated with the topic. Advantageously, by limiting the quantity of content objects that are required to be searched, object management system 410 may reduce the amount of processing resources and time used in identifying the related content items.

When content from services 420-421 is identified as related to a content object distributed by the object management system, object management system 410 may determine an entity associated with the distributed content object. As described herein, when an original content object is translated into one or more content objects that include a synonymous mutations of the content from the original content object, object management system 410 may maintain one or more data structures that define the various mutations to the language elements specific to each iteration of the content object, the entity associated with the content object, or any other information related to defining attributes for the individual content items. For example, a content object may comprise a sensitive document that is required to be accessed by multiple entities (users, groups of users, and the like). As a result, multiple synonymously mutated versions of the content object may be generated for each of the corresponding entities and information associated with the synonymously mutated content objects may be stored in the one or more data structures. Once the synonymously mutated content objects are provided to the entities, the object management system may monitor services, such as services 420-421, to determine whether information derived from the synonymously mutated content objects were used in generating new posts or content objects. In some examples, as the new content objects are generated from services 420-421, the content objects may be compared to the information that is stored by object management system 410 for the synonymously mutated content objects. In comparing the new posts, object management system 410 may identify language elements within the new posts and compare the language elements to that of the previously generated objects to determine whether.

In at least one implementation, when object management system 410 generates a unique synonymously mutated content object for an entity, various sized portions of the content object may include synonymous mutations. For example, when a content object is identified by object management system 410, object management system 410 may identify segments of the original content object (sentences, portions of sentences, paragraphs, portions of paragraphs, and the like) or some other similar segment of the content object. Once the segments are identified, each synonymously mutated content object version of the original content object may comprise different segments than other mutation versions of the same object. Thus, if a first sentence in the original content object is modified from a first version to a second version for a synonymous mutation content object, then the first sentence may be modified to a third version for another synonymous mutation content object. Advantageously, even when a portion of a content object is shared to a service, object management system 410 may identify the source content object for the shared content.

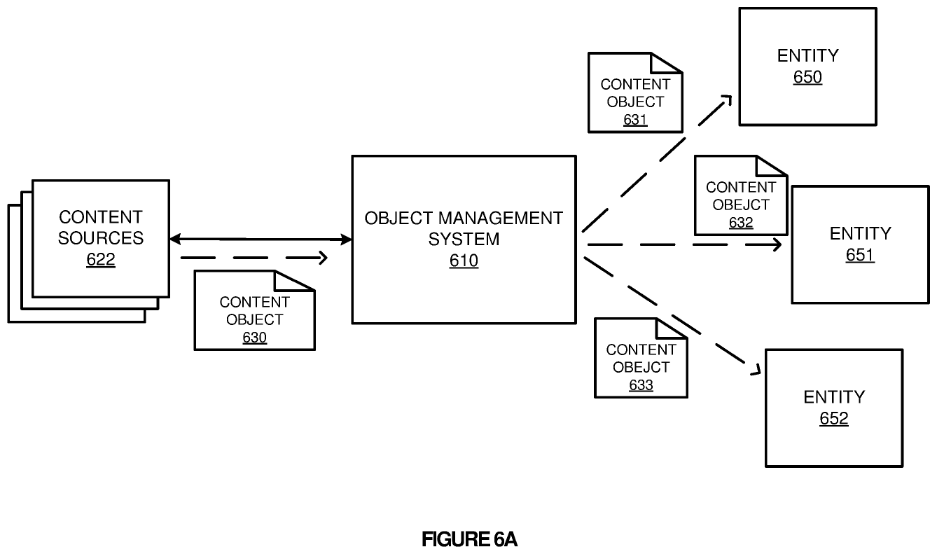

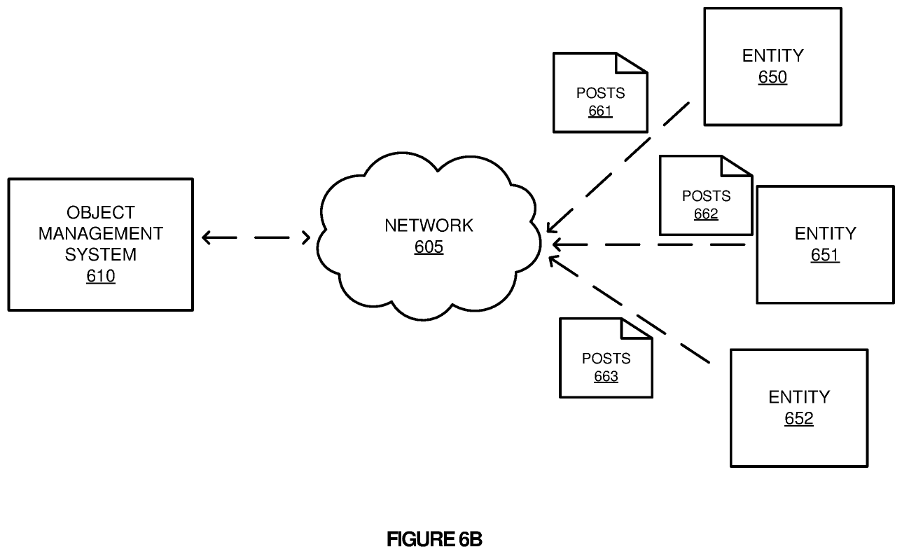

FIGS. 6A-6B illustrate an operational scenario of distributing synonymous mutations of a content object and monitoring usage of the synonymous mutations according to an implementation. FIG. 6A includes content sources 622, object management system 610, and entities 650-652. Content object 630 is provided from content sources 622, and synonymous mutation versions of the content object are generated by object management system 610 as content objects 631-633. FIG. 6B includes object management system 610 and entities 650-652. FIG. 6B further includes network 605 and posts 661-663 that are representative of content items that are generated from entities 650-652.

Referring first to FIG. 6A, a content source in content sources 622 may generate content object 630 that is identified by object management system 610. These content sources 622 may comprise organizations, individuals, or some content sources, and content object 630 may comprise a document, an email, a webpage, a report, or some other content object. In some examples, the content source may directly provide the information to object management system 610, such as when object management system 610 operates as part of a database, however, object management system 610 may monitor other services or databases and determine when a new content object is created for the services or databases. Once content object 630 is identified by object management system 610, object management system 610 may generate content objects 631-633 that correspond to synonymous mutations of content object 630. In some implementations, object management system 610 may, for each of content object of content objects 631-633, identify one or more language elements in content object 630 and translate the language elements to one or more second language elements. The language elements may correspond to a structure of spaces, words, punctuation, abbreviation, acronym, carriage return, or some other structure. For example, object management system may identify a first sentence structure in content object 630 and modify the sentence structure to a second structure for a new synonymous mutation of content object 630. In some implementations, for each content object of content objects 631-633, object management system 610 may identify segmented language elements within content object 630, such as sentences, paragraphs, portions of sentences or paragraphs, or some other language element within content object 630. Once identified, object management system 610 may identify replacement language elements for each of the segments within the content object. These replacement language elements may be different for each of content objects 631-633, such that each portion of the content object is different for each content object. Advantageously, even if only a portion of content object 631 is disseminated to one or more other services, the portion may be distinguished from content objects 632-633. After the content objects 631-633 are generated, content objects 631-633 are supplied to a corresponding entities 650-652.

In some implementations, object management system 610 may store each content object 631-633 to be used in identifying later objects that use information from the content objects. In other implementations, object management system 610 may store content object 630 and generate difference files or sparse files that can be used to identify the differences between the original content object 630 and content objects 631-633.

Turning to FIG. 6B, FIG. 6B demonstrates operations of entities 650-652 following the receipt of content objects 631-633. In particular, object management system 610 may monitor network 605, which may include news websites, social media services, or some other information source to determine when a new post or content object is generated from content objects 631-633. For example, when entity 650 generates posts 661, object management system 610 may identify the generation of the posts and determine the origination of the information in the posts. In some examples, object management system 610 may perform pattern matching on content objects that are generated and provided to network 605. This pattern matching may be used to match data points and/or language elements to previously generated content objects. For example, when content objects 631-633 are generated and correspond to a report, the report may be divided into multiple portions or segments, and each segment may be translated into an alternative version for content objects 631-633. Thus, if a segment of content object 630 corresponded to a sentence, each content object of content objects 631-633 may receive a different version of the sentence. This permits object management system 610 to differentiate between the sources of the various posts. Consequently, even if a sentence were copied and included in a post from one of entities 650-652, object management system 610 may be capable of identifying the post and the source entity for the post.

In some implementations, in determining whether a post is related to a content object that was provided to entities 650-652, object management system 610 may monitor posts to various services and determine whether the post is related to the topic or topics of content object 630. To determine whether the post is related to content object 630, object management system 610 may monitor for data points that originated from content object 630, wherein the data points may comprise numerical values, names, facts, opinions, or some other similar information that could be derived from content object 630. For example, if content object 630 indicated a monetary value associated with an object, object management system 610 may monitor for the monetary value in posts to various services of network 605. Once a data point is identified within a post, network 605 may perform operations to match language elements in the post to content objects 631-633 that were provided to entities 650-652.

In some examples, in addition to determining the source of a post, object management system 610 may further maintain or monitor how information is distributed in network 605. This monitoring may include the quantity of posts the are generated from each content object of content objects 631-633, a hierarchy or distribution map related to each content object 631-633, or some other information related to the distribution of information related to content object 630. As an example, a first post in posts 661 may be generated from information of content object 631 and provided to a first news source. Once provided, users of the news source may generate additional posts that copy information from the first news source. As the additional posts are generated, object management system 610 may determine that they include text portions, a uniform resource locator, or some other information that associates the additional posts with the post from the first new source. Consequently, a map or hierarchy may be generated that determines where the information from a content object was distributed and may further provide a timeline of the distribution. Based on the map or hierarchy, object management system 610 may generate an interface for display that indicates that distribution of the information from one or more content objects 631-633. The interface may indicate a graph of the distribution of information, may indicate a timeline for the distribution of the information, or may provide some other demonstration of the data collected for the various posts related to the content object, including combinations thereof.

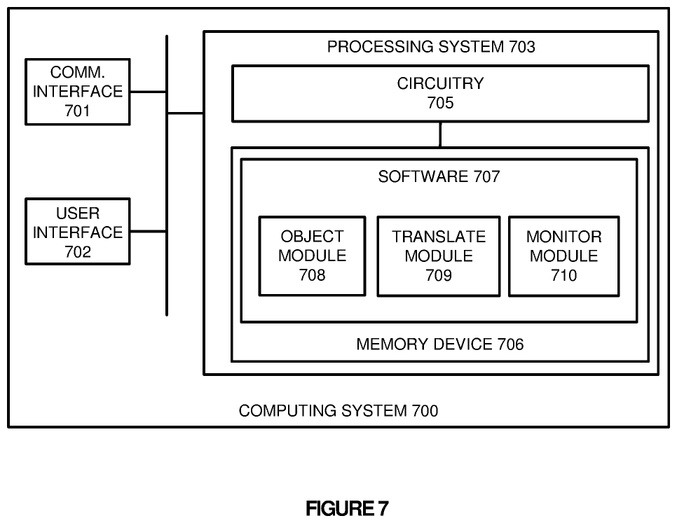

FIG. 7 illustrates an object management computing system 700 according to an implementation. Computing system 700 is representative of any computing system or systems with which the various operational architectures, processes, scenarios, and sequences disclosed herein for an object management system may be implemented. Computing system 700 is an example of object management system 110 of FIG. 1, although other examples may exist. Computing system 700 comprises communication interface 701, user interface 702, and processing system 703. Processing system 703 is linked to communication interface 701 and user interface 702. Processing system 703 includes processing circuitry 705 and memory device 706 that stores operating software 707. Computing system 700 may include other well-known components such as a battery and enclosure that are not shown for clarity.

Communication interface 701 comprises components that communicate over communication links, such as network cards, ports, radio frequency (RF), processing circuitry and software, or some other communication devices. Communication interface 701 may be configured to communicate over metallic, wireless, or optical links. Communication interface 701 may be configured to use Time Division Multiplex (TDM), Internet Protocol (IP), Ethernet, optical networking, wireless protocols, communication signaling, or some other communication format—including combinations thereof. In some implementations, communication interface 701 may be configured to communicate with client computing systems, wherein the client computing systems may request and receive content objects from computing system 700. In some implementations, communication interface 701 may further communicate with one or more services, such as social networking services, news provider services, or some other similar service to monitor posts and use of information from the content objects provided to the various client computing systems.

User interface 702 comprises components that interact with a user to receive user inputs and to present media and/or information. User interface 702 may include a speaker, microphone, buttons, lights, display screen, touch screen, touch pad, scroll wheel, communication port, or some other user input/output apparatus—including combinations thereof. User interface 702 may be omitted in some examples.

Processing circuitry 705 comprises microprocessor and other circuitry that retrieves and executes operating software 707 from memory device 706. Memory device 706 may include volatile and nonvolatile, removable and non-removable media implemented in any method or technology for storage of information, such as computer readable instructions, data structures, program modules, or other data. Memory device 706 may be implemented as a single storage device, but may also be implemented across multiple storage devices or sub-systems. Memory device 706 may comprise additional elements, such as a controller to read operating software 707. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 705 is typically mounted on a circuit board that may also hold memory device 706 and portions of communication interface 701 and user interface 702. Operating software 707 comprises computer programs, firmware, or some other form of machine-readable program instructions. Operating software 707 includes object module 708, translate module 709, and monitor module 710, although any number of software modules may provide the same operation. Operating software 707 may further include an operating system, utilities, drivers, network interfaces, applications, or some other type of software. When executed by processing circuitry 705, operating software 707 directs processing system 703 to operate computing system 700 as described herein.

In one implementation, object module 708 directs processing system 703 to identify a content object obtained from a content source, wherein the content object may comprise a document, program code, an email, a webpage, or some other type of content object. Once a content object is identified, translate module 709 directs processing system 703 to identify one or more language elements in a first structure from the content object, wherein the language elements may comprise a sequence of characters, words, spaces, punctuation, carriage returns, or some other language element. After identifying the one or more language elements, translate module 709 further translates the one or more language elements in the first structure to a second structure. As an example, if the identified content object corresponded to program code for an application, translate module 709 may identify one or more lines in the code that correspond to a first structure. Once identified the one or more lines in the first structure may be translated into a second structure, wherein the second structure may provide a synonymous mutation of the language element in the first structure. These changes may include modifications to the functions of the first structure, modifications to the variables (names, types, etc.) used in the first structure, or some other modification that provide synonymous mutations of the first structure. Thus, although a language element in the program code may be changed from a first structure to a second structure, the functionality may be maintained in the second structure.

Once the one or more language elements are translated to the second structure, translate module 709 further generates a second content object from the content object by replacing the one or more language elements in the first structure with one or more language elements in the second structure. The second content object may then be provided for display to a corresponding entity associated with the second content object. In some implementations, when a new content object is identified, multiple synonymously mutated versions are generated for entities capable of accessing the new content object. This ensures that although each of the entities are provided with a synonymous version of the original content object, the entities are not provided with the original content object itself. In some implementations, the content objects may be generated for the various entities when the content object is obtained. In other implementations, the content objects may be generated when they are requested from each of the entities. Once generated, computing system 700 may maintain information about each of the generated content objects, wherein the information may include the full object, information to recreate the object from the original content object, the entity or entities associated with the content object, or some other information.

After the content objects are generated as synonymously mutated versions of the original content object, monitor module 710 further monitors for when a third content object is provided in one or more services and includes information from the generated content object. The services may comprise news web pages, social media services, blog pages, or some other type of service. For example, a web service may post an article and the language within the article may be compared to previously provided content objects to determine the entity that was the source of the information in the article. In comparing a newly identified article with a previously provided content object, monitor module 710 may identify language elements and compare the language elements to the unique language element that were provided to the previously distributed content objects, wherein the language elements In some implementations, monitor module 710 may identify whether a content object is related to a topic of an original content object. This may be based on facts, opinions, or some other data point within the content object. Once identified as being related to a particular content object, language elements may be compared against the synonymous mutations to determine a source entity for the content object.

In some implementations, when a new content object is identified at a service of the one or more monitored services, computing system 700 may generate a notification for display to an administrator associated with the original content object. The notification may provide various information about the new content object, including an identifier for the original content object on which the new content object is based, the service on which the new content object was posted, the entity that was associated with content, or some other information. In some implementations, computing system 700 may maintain propagation information related to how posts are generated from the synonymous mutations. This propagation information may include the quantity of posts related to one or more of the synonymous mutations, a timeline the posts related to one or more of the synonymous mutations, or some other information related. The information may be displayed to the administrator associated with original content object in some examples.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method comprising:
identifying a content object obtained from a content source, wherein the content object comprises a document or program code;
generating second content objects derived from the first content object, wherein each of the second content objects is unique in relation to the other second content objects, and wherein generating each of the second content objects comprises:
identifying one or more language elements in a first structure from the content object;
translating the one or more language elements in the first structure to a second structure, wherein the second structure provides synonymous mutations of the first structure;
generating the second content object from the content object by replacing the one or more language elements in the first structure with the one or more language elements in the second structure;
distributing, for display, the second content objects to entities, wherein each entity receives a different content object of the second content objects;
identifying a third content object; and
determining an entity of the entities associated with the third content object based on one or more language elements in the third content object in relation to the one or more language elements in the second content objects.

2. The method of claim 1, wherein first structure comprises a sequence of one or more words, characters, punctuation elements, spaces, or carriage returns.

3. The method of claim 1, wherein the first structure comprises a sequence of one or more punctuation elements and spaces, wherein the first structure comprises a first quantity of spaces, and wherein translating the one or more language elements in the first structure to the second structure comprises adding or subtracting to the first quantity of spaces.

4. The method of claim 1, wherein identifying the third content object comprises identifying the third content object as a post to a social media service, news service, blog service, or email service.

5. The method of claim 1 further comprising:
identifying fourth content objects;
for each of the fourth content objects, determining an entity of the entities associated with the fourth content object based on one or more language elements in the fourth content object in relation to the one or more language elements in the second content;
determining distribution information associated with each of the entities based on the determination of the entities associated with the third object and the fourth content objects; and
generating a display of the distribution information.

6. The method of claim 1, wherein the distribution information comprises a quantity of posts from each of the entities related to the content object.

7. (canceled)

8. The method of claim 1, wherein identifying the third content object comprises identifying one or more data points in the data object that relates to the data object.

9. The method of claim 1, wherein the entities each comprise one or more users.

10. An apparatus comprising:
one or more non-transitory computer readable storage media;
a processing system operatively coupled to the one or more non-transitory computer readable storage media; and
program instructions stored on the one or more non-transitory computer readable storage media that, when executed by the processing system, direct the processing system to:
identify a content object obtained from a content source, wherein the content object comprises a document or program code;
generate second content objects derived from the first content object, wherein each of the second content objects is unique in relation to the other second content objects, and wherein generating each of the second content objects comprises:
identifying one or more language elements in a first structure from the content object;
translating the one or more language elements in the first structure to a second structure; and
generating a second content object from the content object by replacing the one or more language elements in the first structure with the one or more language elements in the second structure;
distribute, for display, the second content objects to entities, wherein each entity receives a different content object of the second content objects;
identifying a third content object; and
determine an entity of the entities associated with the third content object based on one or more language elements in the third content object in relation to the one or more language elements in the second content objects.

11. The apparatus of claim 10, wherein first structure comprises a sequence of one or more words, punctuation elements, spaces, or carriage returns.

12. The apparatus of claim 10, wherein the first structure comprises a sequence of one or more punctuation elements and spaces, wherein the first structure comprises a first quantity of spaces, and wherein translating the one or more language elements in the first structure to the second structure comprises adding or subtracting to the first quantity of spaces.

13. The apparatus of claim 10, wherein identifying the third content object comprises identifying the third content object as a post to a social media service, news service, blog service, or email service.

14. The apparatus of claim 10, wherein the program instructions further direct the processing system to:
identify fourth content objects;
for each of the fourth content objects, determine an entity of the entities associated with the fourth content object based on one or more language elements in the fourth content object in relation to the one or more language elements in the second content;
determine distribution information associated with each of the entities based on the determination of the entities associated with the third object and the fourth content objects; and
generate a display of the distribution information.

15. The apparatus of claim 10, wherein the distribution information comprises a quantity of posts from each of the entities related to the content object.

16. (canceled)

17. The apparatus of claim 10, wherein identifying the third content object comprises identifying one or more data points in the data object that relates to the data object.

18. The apparatus of claim 17, wherein the entities each comprise one or more users.

19. A method comprising:
identifying a content object obtained from a content source;
identifying one or more language elements in a first structure from the content object, wherein the first structure comprises a sequence of at least characters, punctuation elements, or spaces;
translating the one or more language elements in the first structure to a second structure;
generating a second content object from the content object by replacing the one or more language elements in the first structure with the one or more language elements in the second structure;
storing the second content object with one or more other content objects generated from the content object, wherein each content object of the second content object and the one or more other content objects is associated with a set of one or more users, and wherein each content object of the second content object and the one or more other content objects is a unique synonymous mutation of the content object;
identifying the third content object;
determining whether the third content object is derived from the second content object or the one or more other content objects based on a comparison of language elements in the third content object to language elements in the second content object and the one or more other content objects; and
when the third content object is derived from the second content object, generating a notification indicating the set of one or more users associated with the second content object are responsible for the generation of the third content object.

20. The method of claim 19, wherein the content object comprises a document or program code.
